(19) United States
(12) Patent Application Publication
(10) Pub. No.: US 2015/0206473 A1
(43) Pub. Date: Jul. 23, 2015

(54) IMAGE PROCESSING CONTROLLER, DISPLAY APPARATUS AND DRIVING METHOD THEREOF

(71) Applicant: Samsung Display Co., Ltd., Yongin-City (KR)

(72) Inventors: JunYong AHN, Seoul (KR); Jongjin LEE, Yongin-si (KR); HyunSeok KO, Yongin-si (KR); Sangsu HAN, Seoul (KR)

(21) Appl. No.: 14/472,625

(22) Filed: Aug. 29, 2014

(30) Foreign Application Priority Data
Jan. 20, 2014 (KR) 10-2014-0006826

(51) Int. Cl. G09G 3/20

(52) U.S. Cl. CPC G09G 3/2044; G09G 2320/0247; G09G 2310/08

(57) ABSTRACT

An image processing controller of a display apparatus includes: a memory configured to store a plurality of dithering maps; and a dithering unit configured to receive an image signal and a control signal and to output a data signal, where the dithering unit selects a frame set of H frame sets based on the control signal, where H is a positive integer, and each of the H frame set corresponds to the plurality of dithering maps in a predetermined order, and the dithering unit selects dithers the image signal sequentially with reference to the plurality of dithering maps in the selected frame set, and outputs the dithered signal as the data signal.

This application claims priority to Korean Patent Application No. 10-2014-0006826, filed on Jan. 20, 2014, and all the benefits accruing therefrom under 35 U.S.C. §119, the content of which in its entirety is herein incorporated by reference.

### BACKGROUND

Exemplary embodiments of the invention disclosed herein relate to an image processing controller, a display apparatus, and a driving method thereof for displaying an image.

A display apparatus typically includes a display panel and a panel driving unit. The display panel includes a plurality of pixels connected respectively to a plurality of gate lines and a plurality of data lines. The panel driving unit includes a gate driver that provides a gate signal to the plurality of gate lines, a data driver that provides grayscale voltages to the plurality of data lines, and a timing controller that controls the gate drivers and the data drivers.

The timing controller may output a data signal by applying a dithering map to an image signal provided externally for improving display quality of an image displayed on the display panel. Due to such a dithering process, an image having larger grayscale than a bit width of the data signal may be represented. However, the dithering process may cause horizontal or vertical stripes to be visually recognized or cause flickering, which results in deterioration of display quality of the display apparatus. In addition, when the display apparatus displays an identical image for a long time, an afterimage occurs due to such a dithering process.

### SUMMARY

Exemplary embodiments of the invention provide an image controller with improving display quality.

Exemplary embodiments of the invention also provide a driving method of a display apparatus for improving display quality.

An exemplary embodiment of the invention provides an image processing controller including: a memory configured to store a plurality of dithering maps; and a dithering unit configured to receive an image signal and a control signal and to output a data signal, where the dithering unit selects a frame set of H frame sets based on the control signal, where H is a positive integer, and each of the H frame set corresponds to the plurality of dithering maps in a predetermined order, and the dithering unit selects dithers the image signal sequentially with reference to the plurality of dithering maps in the selected frame set, and outputs the dithered signal as the data signal.

In an exemplary embodiment, the plurality of dithering maps in the H frame sets may have a complete permutation relationship.

In an exemplary embodiment, each of the plurality of dithering maps may correspond to 8×8 pixels.

In an exemplary embodiment, a sum of polarities of dithering values in each of the plurality of dithering maps may be zero (0), and a sum of polarities of the plurality of dithering maps included in each of the H frame sets may be zero (0).

In an exemplary embodiment, the control signal may comprise a vertical sync signal and a data enable signal.

In an exemplary embodiment, the dithering unit may comprise a counter circuit configured to output a second map count signal, based on which a dithering map of the plurality of dithering maps is selected from the memory in synchronization with the vertical sync signal and the data enable signal.

In an exemplary embodiment, the counter circuit may include: a horizontal counter configured to output a horizontal count signal in synchronization with the data enable signal; a vertical counter configured to output a vertical count signal in synchronization with the data enable signal; a first map counter configured to output a first map count signal, a value of which is increased by a first reference value in synchronization with the vertical sync signal; and a second map counter configured to output a second map count signal, a value of which is increased by a second reference value in synchronization with the vertical sync signal, where the value of the second map count signal may be increased by a third reference value when the first map count signal reaches a fourth reference value.

In an exemplary embodiment, the dithering unit may select a dithering map corresponding to the second map count signal from the plurality of dithering maps, and output the data signal by dithering the image signal using a dithering value corresponding to the horizontal and vertical count signals in the selected dithering map.

In an exemplary embodiment, the second map counter may include, a comparator configured to compare a value of the first map count signal and the fourth reference value, and to output a comparison signal based on a comparison result thereof; a selector configured to receive the second reference value and the third reference value, and to output, as an addition value, one of the second reference value and the third reference value in response to the comparison signal; and an adder configured to add the addition value and a value of a previous second map count signal in synchronization with the vertical sync signal and to output the second map count signal based on an addition result thereof, where the second map count signal is provided to the adder as the previous count signal of the adder.

In an exemplary embodiment, a bit width of the adder may be set based on the number of the plurality of dithering maps.

In an exemplary embodiment, the first map counter may include an adder configured to add the first reference value and a value of a previous first map count signal in synchronization with the vertical sync signal, and to output the first map count signal based on an addition result thereof, where a bit width of the adder is set based on the number of the plurality of dithering maps.

In an exemplary embodiment, the plurality of dithering maps may include J dithering maps in a predetermined order, where J is a positive integer, and the dithering unit may output the data signal by dithering the image signal with reference the plurality of dithering maps sequentially from an h-th dithering map in the J dithering maps when an h-th frame set is selected from the H frame sets, wherein h is an integer satisfying the following inequation: 0≦h≦H−1.

In another exemplary embodiment of the invention, a display apparatus includes: a display panel including a plurality of data lines, a plurality of gate lines crossing the plurality of data lines, and a plurality of pixel connected to the plurality of data lines and the plurality of gate lines; a data driver configured to drive the plurality of data lines; a gate driver configured to drive the plurality of gate lines; and a timing controller configured to control the data driver and the gate driver to display an image on the display panel, where the timing controller comprises: a memory configured to store a plurality of dithering maps; and a dithering unit configured to receive an image signal and a control signal and to output a data signal, where the dithering unit selects a frame set of H frame sets based on the control signal, where H is a positive integer, and each of the H frame sets corresponds to the plurality of dithering maps in a predetermined order, and the dithering unit dithers the image signal sequentially with reference to the plurality of dithering maps in the selected frame set, and outputs the dithered signal to the data driver as the data signal.

In an exemplary embodiment, the plurality of dithering maps in the H frame sets may have a complete permutation relationship.

In an exemplary embodiment, each of the plurality of dithering maps may include dithering values corresponding to 8×8 pixels.

In an exemplary embodiment, the control signal may include a vertical sync signal and a data enable signal, and the dithering unit may include a counter circuit configured to output a second map count signal, based on which a dithering map of the plurality of dithering maps is selected from the memory in synchronization with the vertical sync signal and the data enable signal.

In an exemplary embodiment, the counter circuit may include: a horizontal counter configured to output a horizontal count signal in synchronization with the data enable signal; a vertical counter configured to output a vertical count signal in synchronization with the data enable signal; a first map counter configured to output a first map count signal, a value of which is increased by a first reference value in synchronization with the vertical sync signal; and a second map counter configured to output a second map count signal, a value of which is increased by a second reference value in synchronization with the vertical sync signal, where the value of the second map count signal may be increased by a third reference value when the first map count signal reaches a fourth reference value.

In an exemplary embodiment, the second map counter may include, a comparator configured to compare the value of the first map count signal and the fourth reference value, and to output a comparison signal based on a comparison result thereof; a selector configured to receive the second reference value and the third reference value, and to output, as an addition value, one of the second reference value and the third reference value in response to the comparison signal; and an adder configure to add the addition value and a value of a previous second map count signal in synchronization with the vertical sync signal and to output the second map count signal based on an addition result thereof, where the second map count signal may be provided to the adder as the previous count signal of the adder, and a bit width of the adder may be set based on the number of the plurality of dithering maps.

In another exemplary embodiment of the invention, a driving method of a display apparatus include: receiving an image signal; outputting a data signal by dithering the image signal with reference to a dithering map of a plurality of dithering maps for each frame; and providing the data signal to a display panel of the display apparatus, where the outputting the data signal includes: selecting a frame set of H frame sets, where H is a positive integer, and each of the H frame sets corresponds to the plurality of dither maps in a predetermined order; and outputting the data signal by dithering the image sequentially with reference to the plurality of dithering maps in the selected frame set.

In an exemplary embodiment, the plurality of dithering maps in the H frame sets may have a complete permutation relationship.

### BRIEF DESCRIPTION OF THE FIGURES

The above and other features of the invention will become more apparent by describing in further detail exemplary embodiments thereof with reference to the accompanying drawings, in which:

FIG. 1 is a block diagram illustrating an exemplary embodiment of a display apparatus according to the invention;

FIG. 2 is a block diagram illustrating an exemplary embodiment of the timing controller in FIG. 1;

FIG. 3 is a block diagram illustrating an exemplary embodiment of the memory of FIG. 2;

FIG. 4A illustrates an exemplary embodiment of the dithering maps stored in the memory;

FIG. 4B illustrates an exemplary embodiment of afterimage maps when an image is displayed on the display panel using the dithering maps of FIG. 4A according to a polarity inversion scheme;

FIG. 5 is a diagram illustrating an exemplary embodiment of dithering maps selected by the dithering unit shown in FIG. 3;

FIG. 6 is a block diagram illustrating an exemplary embodiment of a counter circuit shown in FIG. 2; and

FIG. 7 is a block diagram illustrating an exemplary embodiment of first and second map counters shown in FIG. 6.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

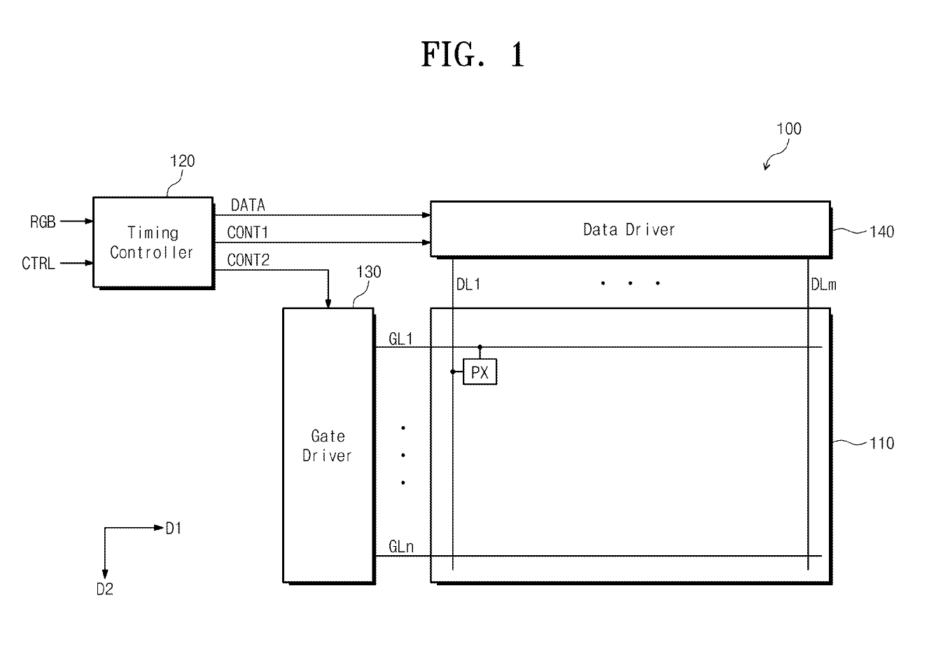

FIG. 1 is a block diagram illustrating an exemplary embodiment of a display apparatus according to the invention.

Referring to FIG. 1, an exemplary embodiment of the display apparatus 100 includes a display panel 110, a timing controller 120, a gate driver 130 and a data driver 140.

In such an embodiment, the display apparatus 100 may be any one of a liquid crystal display (“LCD”) apparatus, a plasma panel display (“PDP”) apparatus, an organic light emitting diode (“OLED”) display apparatus, and a field emission display (“FED”) apparatus, for example.

The display panel 110 includes a plurality of gate lines GL1 to GLn extending substantially in a first direction D1, a plurality of data lines DL1 to DLn extending substantially in a second direction D2, and a plurality of pixels PX respectively connected thereto. The plurality of data lines DL1 to DLn and the plurality of gate lines GL1 to GLn are insulated from each other. Each of the pixels PX may include a switching transistor (not shown) connected to a corresponding data line and a corresponding gate line, a crystal capacitor (not shown) and a storage capacitor (not shown) connected to the switching transistor.

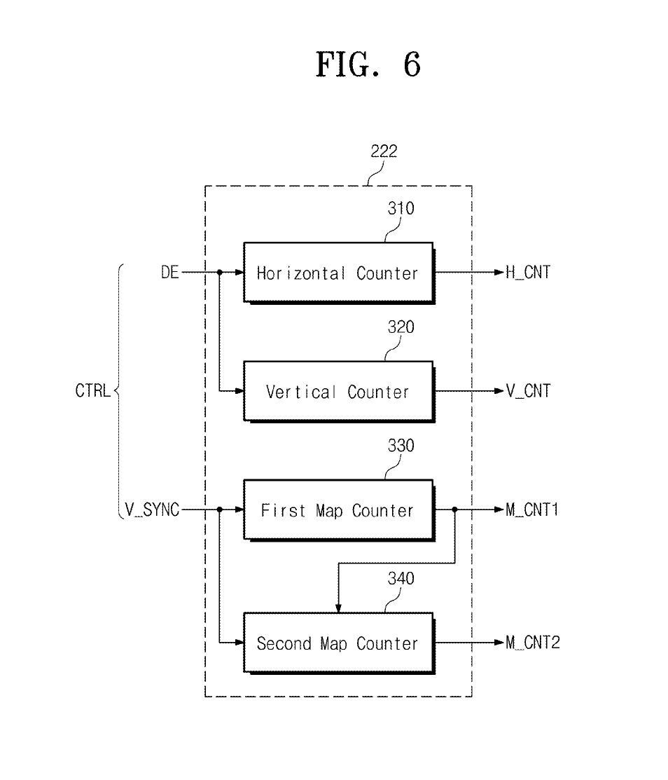

The timing controller 120 externally receives an image signal RGB and a control signal CTRL for controlling a display an image corresponding to the image signal RGB. In one exemplary embodiment, for example, the control signal CTRL includes a vertical sync signal, a horizontal sync signal, a main clock signal, and a data enable signal DE (shown in FIG. 6). The timing controller 120 generates a data signal DATA base on the image signal RGB, e.g., by processing the image signal RGB to correspond to operating conditions of the display panel 110, and provides the data signal DATA to the data driver 140. The timing controller 120 generates a first control signal CONT1 and a second control signal CONT2 based on the control signal CTRL, and provides the first control signal CONT1 to the data driver, and the second control signal CONT2 to the gate driver 130. The first control signal CONT1 may include a horizontal sync start signal, a clock signal and a line latch signal, and the second control signal CONT2 may include a vertical sync start signal and an output enable signal.

The timing controller 120 may perform a gamma-correction on the image signal RGB to output main region image signals, and interpolates the main region image signals to output boundary region image signals between the main region image signals. The timing controller 120 provides the data signal DATA obtained by dithering the image signal RGB to the data driver 140. In an exemplary embodiment, the timing controller 120 may include a processor. An operation of the timing controller 120 will be described later in greater detail.

The gate driver 130 drives the plurality of gate lines GL1 to GLn based on the second control signal CONT2 from the timing controller 120. In an exemplary embodiment, the gate driver 130 may be implemented with a circuit using an amorphous silicon gate, an oxide semiconductor, a crystalline semiconductor or a polycrystalline semiconductor, and may be disposed on a substrate of the display panel 110. In an alternative exemplary embodiment, the gate driver 130 may be integrated into a gate driving integrated circuit (“IC”) and connected to a side of the display panel 110.

The data driver 140 outputs grayscale voltages for driving the data lines DL1 to DLn based on the data signal DATA and the first control signal CONT1 from the timing controller 120.

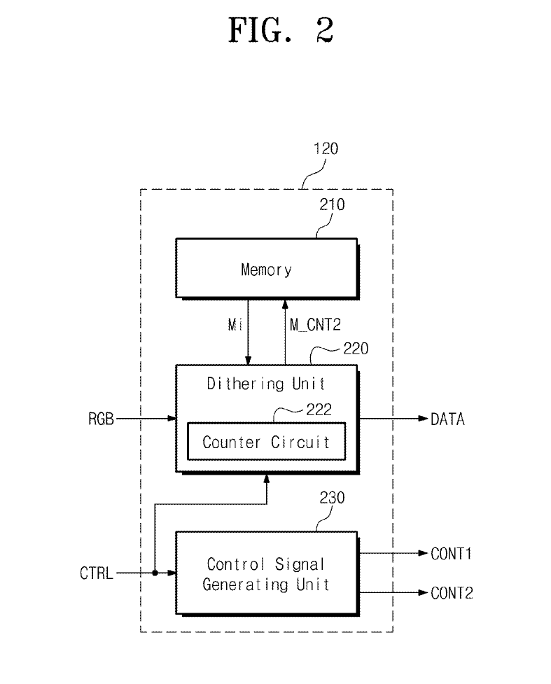

FIG. 2 is a block diagram illustrating an exemplary embodiment of the timing controller shown in FIG. 1.

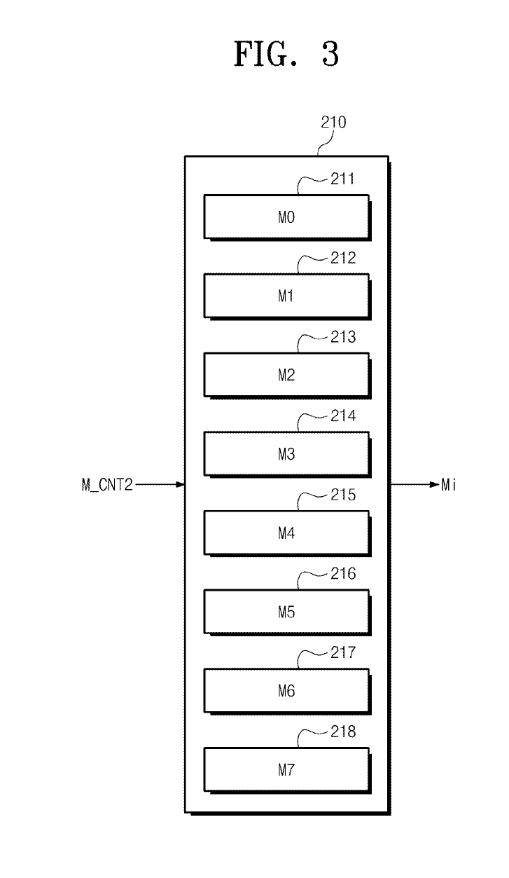

Referring to FIG. 2, an exemplary embodiment of the timing controller 120 includes a memory 210, a dithering unit 220 and a control signal generating unit 230. The memory 120 stores a plurality of dithering maps. The dithering unit 220 receives the image signal RGB and the control signal CTRL, and outputs the data signal DATA that the image signal RGB is dithered with reference to a dithering map of the plurality of dithering maps stored in the memory 210. The dithering unit 220 outputs a second map count signal M_CNT2 to the memory 210. The dithering unit 220 includes a counter circuit 222. A configuration of the counter circuit 222 will be described later in detail. The memory 210 outputs a dithering map Mi (shown in FIG. 3) corresponding to the second map count signal M_CNT2 to the dithering unit 220.

The control signal generating unit 230 outputs first and second control signals CONT1 and CONT2 based on the control signal CTRL. In such an embodiment, as shown in FIG. 1, the first control signal CONT1 is provided to the data driver 140, and the second control signal CONT2 is provided to the gate driver 130.

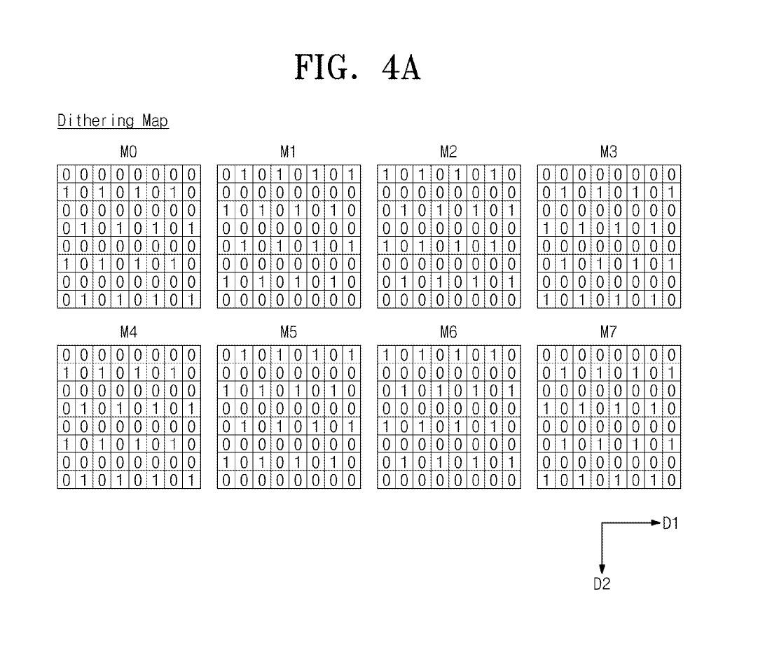

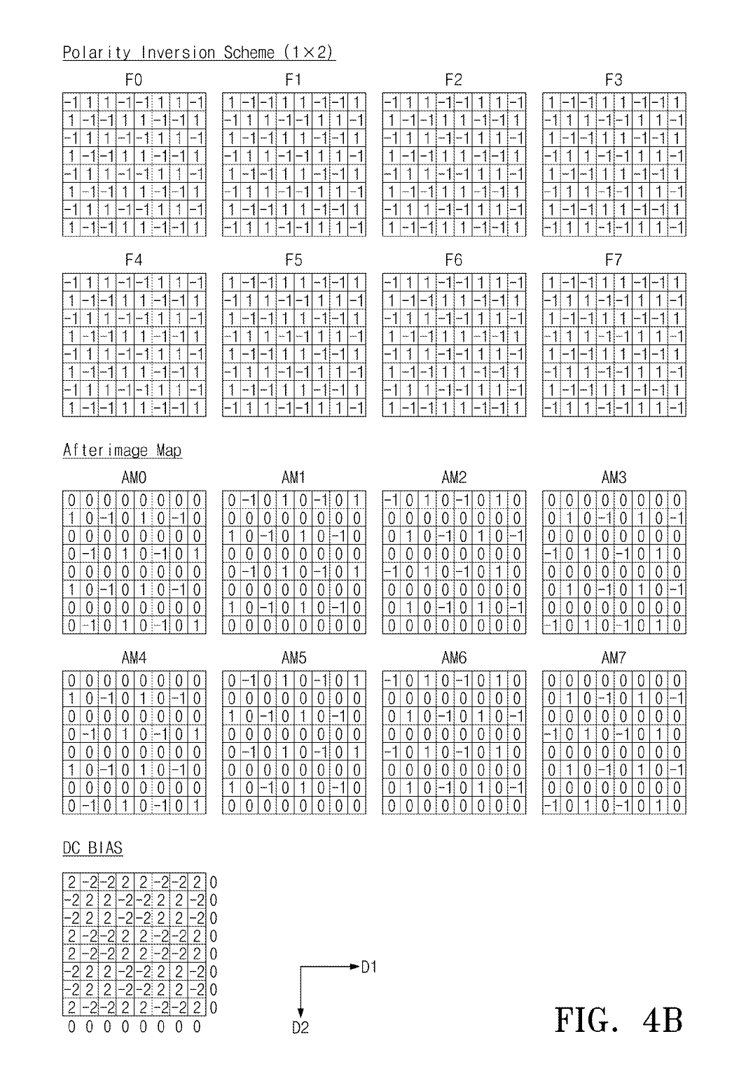

FIG. 3 is a block diagram illustrating an exemplary embodiment of the memory shown in FIG. 2. FIG. 4A illustrates an exemplary embodiment of the dithering maps stored in the memory, and FIG. 4B illustrates an exemplary embodiment of afterimages when an image is displayed on the display panel using the dithering maps shown in FIG. 4A according to polarity inversion scheme.

Referring to FIG. 3, the memory 210 includes memory regions, e.g., first to eighth regions 211 to 218. The memory regions 211 to 218 store a plurality of dithering maps, e.g., zeroth (0^{th}) to seventh (7^{th}) dithering maps M0 to M7, respectively. Among the memory regions 211 to 218, a dithering map Mi stored in a region corresponding to the second map count signal M_CNT2 input from the dithering unit 220 shown in FIG. 2 is output from the memory 210 to the dithering unit 220.

Each of the 0^{th} to 7^{th} dithering maps stored in the memory regions 211 to 218 includes dithering values corresponding to 8×8 pixels of the display panel 110 (in FIG. 1). A dithering value corresponding to each pixel is ‘0’ or ‘1’. Dithering patterns of the 0^{th} to 7^{th} dithering maps M0 to M7 are different from one another. In an exemplary embodiment, the memory 210 stores 8 dithering maps M0 to M7, as shown in FIG. 4. However, the number of dithering maps is not limited thereto, and various numbers of dithering patterns may be included in an alternative exemplary embodiment. In an exemplary embodiment, dithering patterns of the 0^{th} to 7^{th} dithering maps M0 to M7 may be variously modified. The 0^{th} to 7^{th} dithering maps M0 to M7 may be arrayed in a predetermined order, e.g., an optimal order to minimize dither noise such as vertical stripes, horizontal stripes, or flickers.

The grayscale voltages provided to the display panel 110 from the data driver 140 shown in FIG. 1 may be driven in a polarity inversion scheme. As shown in FIG. 4B, in an exemplary embodiment, the display device may be driven in a 1×2 polarity inversion scheme, such that a grayscale voltage provided to a data line may have opposite polarities every one pixel based on a common voltage, and the grayscale voltages provided to neighboring data lines may have opposite polarities every two pixels. In FIG. 4B, a positive polarity grayscale voltage having a higher voltage level than a common voltage is represented as ‘1’, and a negative polarity grayscale voltage having a lower voltage level than the common voltage is represented as ‘−1’. In such an embodiment, grayscale voltages provided to the data lines are driven with different polarities every frame.

In an exemplary embodiment, where a predetermined 8×8 pixels of the display panel 110 are driven with the 1×2 polarity inversion scheme from a 0^{th} frame F0 to a 7^{th} frame F7, the 0^{th} to 7^{th} dithering maps M0 to M7 are sequentially selected by the dithering unit 220. The afterimage maps AM0 to AM7 of the 0^{th} frame F0 to the 7^{th} frame F7 based on the 0^{th} to 7^{th} dithering maps M0 to M7, respectively, are shown in FIG. 4B. In FIG. 4B, “DC BIAS” represents accumulated values of direct current (“DC”) biases of the afterimage maps AM0 to AM7. For the 0^{th} frame F0 to the 7^{th} frame F7, the DC biases respectively accumulated in the 8×8 pixels are ‘2’ or ‘−2’. In an exemplary embodiment, the DC biases of pixels arrayed in the first direction D1 are ‘0’, and the DC biases of pixels arrayed in the second direction D2 are ‘0’, such that visually recognized horizontal stripes or vertical stripes, or flickering may be effectively prevented from occurring on an image displayed on the display panel 110.

When the dithering unit 220 performs dithering using a 0^{th} dithering map M8 at an 8^{th} frame after the 7^{th} frame, that is, the dithering unit 220 performs dithering by repetitively using the 0^{th} to 7^{th} dithering maps M0 to M7 in the order of M0, M1, M2, M3, M4, M5, M6, M7, M0, M1, M2, etc., after the eight frames (the 0^{th} to 7^{th} frames), the DC bias of each pixel is ‘2’ or ‘−2’ such that a grayscale voltage difference between adjacent pixels may be recognized as dither noise according to a pattern of an image displayed on the display panel 110. In one exemplary embodiment, for example, a left uppermost pixel among 8×8 pixels, e.g., a pixel in the first row and the first column, has the DC bias of ‘−1’ at 2^{nd}, 6^{th}, 10^{th}, 14^{th}, and 18^{th} frames and ‘0’ at the rest of the frames. That is, the DC bias of the left upper most pixel is periodically ‘−1’, and dither noise may be thereby recognized.

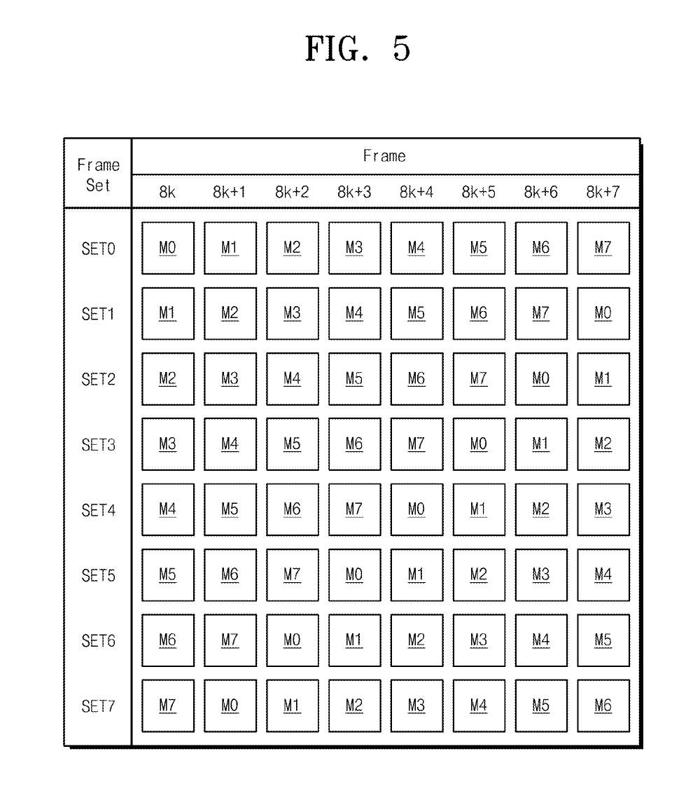

FIG. 5 is a diagram illustrating an exemplary embodiment of dithering maps selected by the dithering unit shown in FIG. 2.

Referring to FIG. 5, in an exemplary embodiment, the dithering unit 220 (in FIG. 2) may select one of a plurality of frame sets SET0 to SET7. In such an embodiment, each of the frame sets SET0 to SET7 includes the 0^{th} to 7^{th} dithering maps M0 to M7. In one exemplary embodiment, for example, the dithering unit 220 may sequentially select 8 frame sets SET0 to SET7 and outputs data signal DATA by dithering the image signal RGB sequentially with reference to the dithering maps in the selected frame set. In the table shown in FIG. 5, k=0, 1, 2, . . . , 7.

In such an embodiment, the dithering unit 220 may select a 0^{th} frame set SET0 and output the second map count signal M_CNT2 for sequentially referring to the dithering maps in the order of M0, M1, M2, M3, M4, M5, M6 and M7 from the 0^{th} frame to 7^{th} frame.

The dithering nit 220 may select a first frame set SET1 and outputs\ the second map count signal M_CNT2 for sequentially referring to the dithering maps in the order of M1, M2, M3, M4, M5, M6, M7 and M0 from the 8^{th} frame to 15^{th} frame.

The dithering nit 220 may select a second frame set SET2 and output the second map count signal M_CNT2 for sequentially referring to the dithering maps in the order of M2, M3, M4, M5, M6, M7, M0, and M1 from the 16^{th} frame to 23^{rd} frame.

The dithering nit 220 may select a third frame set SET3 and output the second map count signal M_CNT2 for sequentially referring to the dithering maps in the order of M3, M4, M5, M6, M7, M0, M1, and M2 from the 24^{th} frame to 31^{st} frame.

The dithering nit 220 may select a fourth frame set SET4 and output the second map count signal M_CNT2 for sequentially referring to the dithering maps in the order of M4, M5, M6, M7, M0, M1, M2 and M3 from the 32^{nd} frame to 39^{th} frame.

The dithering nit 220 may select a fifth frame set SET5 and output the second map count signal M_CNT2 for sequentially referring to the dithering maps in the order of M5, M6, M7, M0, M1, M2, M3 and M4 from the 40^{th} frame to 47^{th} frame.

The dithering nit 220 may select a sixth frame set SET6 and output the second map count signal M_CNT2 for sequentially referring to the dithering maps in the order of M6, M7, M0, M1, M2, M3, M4 and M5 from the 48^{th} frame to 55^{th} frame.

The dithering nit 220 may select a seventh frame set SET7 and output the second map count signal M_CNT2 for sequentially referring to the dithering maps in the order of M7, M0, M1, M2, M3, M4, M5 and M6 from the 56^{th} frame to 63^{rd} frame.

In an exemplary embodiment, the 0^{th} to 7^{th} dithering maps included in each of the frame sets SET0 to SET7 have different dithering patterns. In such an embodiment, as described with reference to FIG. 4, a sum of the DC biases of each of the 0^{th} to 7^{th} dithering maps M0 to M7 is ‘0’. In such an embodiment, a sum of the DC biases of the 0^{th} to 7^{th} dithering maps M0 to M7 included in each of the frame sets SET0 to SET7 is also ‘0’.

In an exemplary embodiment, first dithering maps of the respective dithering sets SET0 to SET7 are different from each other. That is, the 0^{th} to 7^{th} dithering maps M0 to M7 in the dithering sets SET0 to SET7 have a complete permutation relationship. Orders of the 0^{th} to 7^{th} dithering maps M0 to M7 included in each of the dithering sets SET0 to SET7 are different from each other. Accordingly, in an exemplary embodiment of the display apparatus 100 having such a configuration, recognition of the dithering noise may be substantially reduced or effectively minimized.

FIG. 6 is a block diagram illustrating an exemplary embodiment of the counter circuit shown in FIG. 2.

Referring to FIG. 6, an exemplary embodiment of the counter circuit 222 includes a horizontal counter 310, a vertical counter 320, a first map counter 330 and a second map counter 340. The horizontal counter 310 outputs a horizontal count signal H_CNT in response to a data enable signal DE included in the control signal CTRL. The vertical counter 320 outputs a vertical count signal V_CNT in response to the data enable signal DE included in the control signal CTRL.

The first map counter 330 outputs a first map count signal M_CNT1 in response to a vertical sync signal V_SYNC included in the control signal CTRL. The second map counter 340 outputs a second map count signal M_CNT2 in response to the vertical sync signal V_SYNC. In such an embodiment, as shown in FIG. 2, the dithering unit 220 dithers the image signal RGB corresponding to each pixel with one value corresponding to the horizontal count signal H_SYNC and the vertical count signal V-SYNC among 8×8 dithered values included in a selected map among the 0^{th} to 7^{th} dithering maps M0 to M7 stored in the memory 210, and outputs the dithered data signal DATA.

The second map count signal M_CNT2 output from the second map counter 340 is provided as a signal for selecting one of a plurality of regions 211 to 218 of the memory 210.

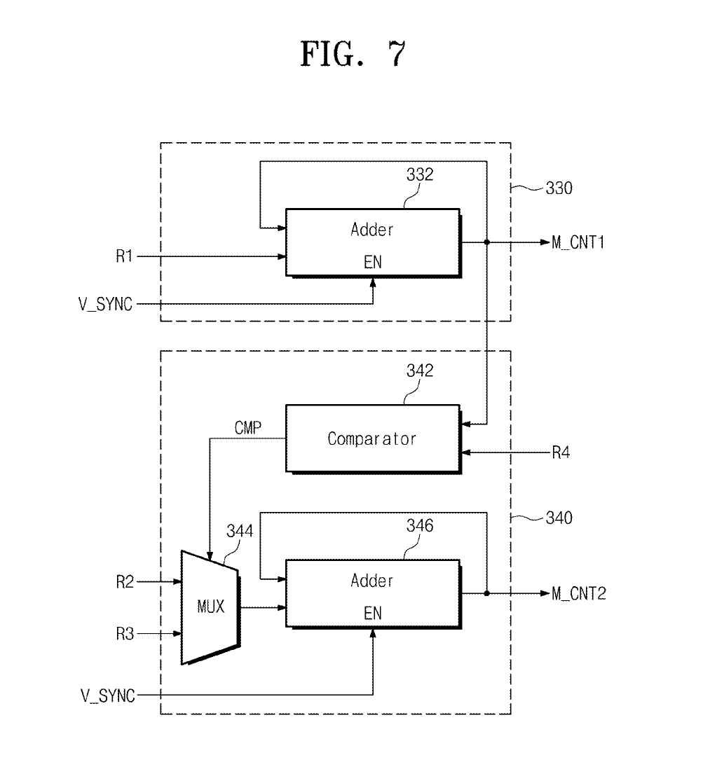

FIG. 7 is a block diagram illustrating an exemplary embodiment of the first and second map counters shown in FIG. 6.

Referring to FIG. 7, an exemplary embodiment of the first map counter 330 includes an adder 332. The adder 332 receives a previous first map count signal M_CNT1, which is output to an output end, and a first reference value R1, and the adder 332 outputs the first map count signal M_CNT1 synchronized with the vertical sync signal V_SYNC input to an enable terminal EN. In such an embodiment, the adder 332 adds the previous first map count signal M_CNT1 and the first reference value R1 in synchronization with the vertical sync signal V_SYNC, and outputs the first map count signal M_CNT1. The vertical sync signal V_SYNC is a pulse signal activated for each frame. In one exemplary embodiment, for example, the first reference signal R1 may be ‘001b’, and the first map count signal M_CNT1 increases by 1 every frame. In such an embodiment, the adder 332 has a 3-bit width and a maximum value of the first map count signal M_CNT1 is ‘111b’. The bit width of the adder 332 may be set based on the number of the 0^{th} to 7^{th} dithering maps M0 to M7.

The second map counter 340 includes a comparator 342, a selector 344 and an adder 346. The comparator 342 receives the first map count signal M_CNT1 and a fourth reference value R4, and outputs a comparison signal CMP. When the first map count signal M_CNT1 matches with the fourth reference value R4, the comparator 342 outputs a comparison signal in a high level. When the first map count signal M_CNT1 does not match with the fourth reference value R4, the comparator 342 outputs a comparison signal in a low level.

The selector 344 outputs one of a second reference value R2 and a third reference value R3 to the adder 346 in response to the comparison signal CMP. In one exemplary embodiment, for example, when the comparison signal CMP has a low level, the selector 344 may output the second reference signal R2 to the adder 346. In such an embodiment, when the comparison signal CMP has a high level, the selector 344 may output the third reference value R3 to the adder 346.

The adder 346 outputs the second map count signal M_CNT2 by adding a previous second map count signal M_CNT2 and a signal output from the selector 344 in synchronization with the vertical sync signal V_SYNC input to the enable terminal EN. In one exemplary embodiment, for example, the second reference value R2 may be ‘001b’ and the third reference value R3 may be ‘010b’. In such an embodiment, the adder 346 has a 3-bit width, and a maximum value of the second map count signal M_CNT2 is ‘111b’. The bit width of the adder 346 may be set based on the number of the 0^{th} to 7^{th} dithering maps M0 to M7.

Referring to FIGS. 5 and 7, the first map count signal M_CNT1 from the 0^{th} to 7^{th} frames sequentially increases by 1 every frame from the 0^{th} frame to 7^{th} frame, and changes in the order of ‘000b’, ‘001b’, ‘010b’, ‘0111b’, ‘100b’, ‘101b’, ‘110b’ and ‘111b’.

When the fourth reference value R4 input to the comparator 342 is ‘111b’, the comparison signal CMP has a low level while the first map count signal M_CNT1 changes in the order of ‘000b’, ‘001b’, ‘010b’, ‘011b’, ‘100b’, ‘101b’ and ‘110b’. The selector 344 outputs the second reference value R2, e.g., ‘001b’, in response to the comparison signal of the low level. Initially, e.g., at the 0^{th} frame, the adder 346 outputs ‘000b’ as the second map count signal M_CNT2. The adder 346 outputs the second map count signal M_CNT2 which changes in the order of ‘001b’, ‘010b’, ‘011b’, ‘100b’, ‘101b’, ‘110b’ and ‘111b’, from the 1^{st} frame to 7^{th} frame.

When the first map count signal is ‘111b’, the comparison signal CMP has a high level. The selector 344 outputs the third reference value R3 to the adder 346 in response to the comparison signal CMP in the high level. Therefore, at the 8^{th} frame, the adder 346 increases the previous second map count signal M_CNT2 ‘111b’ by the third reference value R3 ‘010b’ and outputs ‘001b’ as the second map count signal M_CNT2.

When the first map count signal M_CNT1 is again ‘000b’, the comparator 342 outputs a comparison signal CMP in a low level. Therefore, the second map count signal M_CNT2 changes for each frame from the 8^{th} frame to the 15^{th} frame in the order of ‘001b’, ‘010b’, ‘011b’, ‘100b’, ‘101b’, ‘110b’, ‘111b’ and ‘000b’.

In a similar method, the second map count signal M_CNT2 changes for each frame from 16^{th} frame to 23^{rd} frame in the order of ‘10b’, ‘011b’, ‘100b’, ‘101b’, ‘110b’, ‘111b’, ‘000b’ and ‘001b’. The second map count signal M_CNT2 changes for each frame from 24^{th} frame to 31^{st} frame in the order of ‘011b’, ‘100b’, ‘101b’, ‘110b’, ‘111b’, ‘000b’, ‘001b’ and ‘010b’. The second map count signal M_CNT2 changes for each frame from 32^{nd} frame to 39^{th} frame in the order of ‘100b’, ‘101b’, ‘110b’, ‘111b’, ‘000b’, ‘001b’, ‘010b’ and ‘011b’. The second map count signal M_CNT2 changes for each frame from 40^{th} frame to 47^{th} frame in the order of ‘101b’, ‘110b’, ‘111b’, ‘000b’, ‘001b’, ‘010b’, ‘011b’ and ‘100b’. The second map count signal M_CNT2 changes for each frame from 48^{th} frame to 55^{th} frame in the order of ‘110b’, ‘111b’, ‘000b’, ‘001b’, ‘010b’, ‘011b’, ‘100b’ and ‘101b’. The second map count signal M_CNT2 changes for each frame from 56^{th} frame to 63^{rd} frame in the order of ‘111b’, ‘000b’, ‘001b’, ‘010b’, ‘011b’, ‘100b’, ‘101b’ and ‘110b’.

In such a way, the second map counter 340 changes the second map count signal M_CNT2 for every 8 frames. Accordingly, since the dithering unit 220 (in FIG. 2) changes a selection order of the 0^{th} to 7^{th} dithering maps M0 to M7 for every 8 frames, the recognition of the dithering noise may be substantially minimized.

In an alternative exemplary embodiment, the third reference value R3 may be set to a different value other than ‘010b’. In one exemplary embodiment, for example, when the third reference value R3 is ‘011b’, the second map count signal M_CNT2 may change e.g., (0, 1, 2, 3, 4, 5, 6, 7), (2, 3, 4, 5, 6, 7, 0, 1) or (4, 5, 6, 7, 0, 1, 2, 3). In such an embodiment, an order of the 0^{th} to 7^{th} dithering maps M0 to M7 included in each of the frame sets SET0 to SET7 may become different from each other, and the recognition of dithering noise is thereby substantially minimized.

In exemplary embodiments described herein, a display device minimizes overlap of a plurality of dithering maps by selecting the plurality of dithering maps in a predetermined order. In such embodiments, polarity of an image displayed on a display panel may be effectively prevented from being biased towards one side by periodically changing an output order of the plurality of dithering maps.

The above-disclosed subject matter is to be considered illustrative, and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. An image processing controller comprising:
a memory configured to store a plurality of dithering maps; and
a dithering unit configured to receive an image signal and a control signal and to output a data signal,
wherein
the dithering unit selects a frame set of H frame sets based on the control signal, wherein H is a positive integer, and each of the H frame sets corresponds to the plurality of dithering maps in a predetermined order, and
the dithering unit dithers the image signal sequentially with reference to the plurality of dithering maps in the selected frame set, and outputs the dithered image signal as the data signal.

2. The image processing controller of claim 1, wherein the plurality of dithering maps in the H frame sets has a complete permutation relationship.

3. The image processing controller of claim 1, wherein each of the plurality of dithering maps corresponds to 8×8 pixels.

4. The image processing controller of claim 1, wherein
a sum of polarities of dithering values in each of the plurality of dithering maps is zero (0), and
a sum of polarities of the plurality of dithering maps included in each of the H frame sets is zero (0).

5. The image processing controller of claim 1, wherein the control signal comprises a vertical sync signal and a data enable signal.

6. The image processing controller of claim 5, wherein the dithering unit comprises:
a counter circuit configured to output a second map count signal, based on which a dithering map of the plurality of dithering maps is selected from the memory in synchronization with the vertical sync signal and the data enable signal.

7. The image processing controller of claim 6, wherein the counter circuit comprises:
a horizontal counter configured to output a horizontal count signal in synchronization with the data enable signal;
a vertical counter configured to output a vertical count signal in synchronization with the data enable signal;
a first map counter configured to output a first map count signal, a value of which is increased by a first reference value in synchronization with the vertical sync signal; and
a second map counter configured to output the second map count signal, a value of which is increased by a second reference value in synchronization with the vertical sync signal,
wherein the value of the second map count signal is increased by a third reference value when the first map count signal reaches a fourth reference value.

8. The image processing controller of claim 7, wherein
the dithering unit selects a dithering map corresponding to the second map count signal from the plurality of dithering maps, and outputs the data signal by dithering the image signal using a dithering value corresponding to the horizontal and vertical count signals in the selected dithering map.

9. The image processing controller of claim 8, wherein the second map counter comprises:
a comparator configured to compare the value of the first map count signal and the fourth reference value, and to output a comparison signal based on a comparison result thereof;
a selector configured to receive the second reference value and the third reference value, and to output, as an addition value, one of the second reference value and the third reference value in response to the comparison signal; and
an adder configured to add the addition value and a value of a previous second map count signal in synchronization with the vertical sync signal, and to output the second map count signal based on an addition result thereof,
wherein the second map count signal is provided to the adder as the previous count signal of the adder.

10. The image processing controller of claim 9, wherein a bit width of the adder is set based on the number of the plurality of dithering maps.

11. The image processing controller of claim 8, wherein
the first map counter comprises an adder configured to add the first reference value and a value of a previous first map count signal in synchronization with the vertical sync signal and to output the first map count signal based on an addition result thereof, and
a bit width of the adder is set based on the number of the plurality of dithering maps.

12. The image processing controller of claim 11, wherein
the plurality of dithering maps comprise J dithering maps in a predetermined order, wherein J is a positive integer, and
the dithering unit outputs the data signal by dithering the image signal with reference the plurality of dithering maps sequentially from an h-th dithering map in the J dithering maps when an h-th frame set is selected from the H frame sets, wherein h is an integer satisfying the following inequation: 0≦h≦H−1.

13. A display apparatus comprising:
a display panel comprising:
a plurality of data lines;
a plurality of gate lines crossing the plurality of data lines; and
a plurality of pixels connected to the plurality of data lines and the plurality of gate lines;
a data driver configured to drive the plurality of data lines;
a gate driver configured to drive the plurality of gate lines; and
a timing controller configured to control the data driver and the gate driver to display an image on the display panel,
wherein the timing controller comprises,
a memory configured to store a plurality of dithering maps; and
a dithering unit configured to receive an image signal and a control signal and to output a data signal,
wherein
the dithering unit selects a frame set of H frame sets based on the control signal, wherein H is a positive integer, and each of the H frame sets corresponds to the plurality of dithering maps in a predetermined order, and
the dithering unit dithers the image signal sequentially with reference to the plurality of dithering maps in the selected frame set, and outputs the dithered signal to the data driver as the data signal.

14. The display apparatus of claim 13, wherein the plurality of dithering maps in the H frame sets has a complete permutation relationship.

15. The display apparatus of claim 14, wherein each of the plurality of dithering maps comprises dithering values corresponding to 8×8 pixels.

16. The display apparatus of claim 13, wherein
the control signal comprises a vertical sync signal and a data enable signal, and
the dithering unit comprises a counter circuit configured to output a second map count signal, based on which a dithering map of the plurality of dithering maps is selected from the memory in synchronization with the vertical sync signal and the data enable signal.

17. The display apparatus of claim 16, wherein the counter circuit comprises,
a horizontal counter configured to output a horizontal count signal in synchronization with the data enable signal;
a vertical counter configured to output a vertical count signal in synchronization with the data enable signal;
a first map counter configured to output a first map count signal, a value of which is increased by a first reference value in synchronization with the vertical sync signal; and
a second map counter configured to output the second map count signal, a value of which is increased by a second reference value in synchronization with the vertical sync signal, wherein the value of the second map count signal is increased by a third reference value when the first map count signal reaches a fourth reference value.

18. The display apparatus of claim 17, wherein the second map counter comprises,
a comparator configured to compare the value of the first map count signal and the fourth reference value, and to output a comparison signal based on a comparison result thereof;
a selector configured to receive the second reference value and the third reference value, and to output, as an addition value, one of the value of the second reference value and the third reference value in response to the comparison signal; and
an adder configured to add the addition value and a value of a previous second map count signal in synchronization with the vertical sync signal and to output the second map count signal based on an addition result thereof,
wherein the second map count signal is provided to the adder as the previous count signal of the adder, and
a bit width of the adder is set based on the number of the plurality of dithering maps.

19. A driving method of a display apparatus, comprising:
receiving an image signal;
outputting a data signal by dithering the image signal with reference to a dithering map of a plurality of dithering maps for each frame; and
providing the data signal to a display panel of the display apparatus,
wherein
the outputting the data signal comprises:
selecting a frame set of H frame sets, wherein H is a positive integer, and each of the H frame sets corresponds to the plurality of dither maps in a predetermined order; and
outputting the data signal by dithering the image sequentially with reference to the plurality of dithering maps in the selected frame set.

20. The driving method according to claim 19, wherein the plurality of dithering maps in the H frame sets has a complete permutation relationship.
